(19) United States
(12) Patent Application Publication
(10) Pub. No.: US 2016/0253629 A1
(43) Pub. Date: Sep. 1, 2016

(54) MEETING INITIATION BASED ON PHYSICAL PROXIMITY

(71) Applicant: salesforce.com, inc., San Francisco, CA (US)

(72) Inventors: Bruno Fonzi, San Mateo, CA (US); Amy Catherine Lee, San Mateo, CA (US)

(21) Appl. No.: 14/632,800

(22) Filed: Feb. 26, 2015

(51) Int. Cl. G06Q 10/10; H04W 4/14; H04W 4/02

(52) U.S. Cl. CPC G06Q 10/1095; H04W 4/021; H04W 4/14

(57) ABSTRACT

In an example, a sensor may detect when a device carried or worn by one of the persons of a scheduled meeting is positioned within a predetermined geographic distance from a reference associated with the scheduled meeting. A processing device is configured to initialize a remote capturing component responsive to the detecting. The processing device is configured to send an electronic message including information that is based on an output of the capturing component.

### COPYRIGHT NOTICE

A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever.

### FIELD OF THE INVENTION

One or more implementations relate generally to meeting initiation based on physical proximity in a database network system environment.

### BACKGROUND

The subject matter discussed in the background section should not be assumed to be prior art merely as a result of its mention in the background section. Similarly, a problem mentioned in the background section or associated with the subject matter of the background section should not be assumed to have been previously recognized in the prior art. The subject matter in the background section merely represents different approaches, which in and of themselves may also be inventions.

Software for conducting meetings, e.g. web conferencing software, is known. Web conferencing software may include streaming video features, and may be used with or without an equipped meeting room, e.g. a room with conferencing features such as a large display, microphone, speakers, or the like, or combinations thereof.

Several activities may be associated with a meeting. There is of course activity of the meeting itself, but also activities that occur before the meeting (including but not limited to scheduling between participants, room reservation, etc.) and the activities that occur after the meeting (including but not limited to sharing information collected during the meeting). These activities may utilize web conferencing software and other disparate systems.

For instance, a meeting may be scheduled using calendaring software, i.e. a chairperson or an administrator may input information into calendaring software to cause invites to be sent to the meeting participants. Separately, the chairperson or administrator may input information into a different system to schedule a room for the meeting. Separately, the chairperson or administrator may input information into web conferencing software to utilize, say, desktop sharing during the meeting. Other systems may be utilized before, during, or after the meeting for the purpose of organizing, sharing information, etc.

The information separately input into one system may be redundant with information separately input into another system. Each separate inputting into multiple systems may be associated with network traffic, and other consumption of resources of electronic devices. The disclosure that follows solves this and other problems.

### BRIEF DESCRIPTION OF THE DRAWINGS

In the following drawings like reference numbers are used to refer to like elements. Although the following figures depict various examples, the one or more implementations are not limited to the examples depicted in the figures.

The included drawings are for illustrative purposes and serve to provide examples of possible structures and operations for the disclosed inventive systems, apparatus, methods and computer-readable storage media. These drawings in no way limit any changes in form and detail that may be made by one skilled in the art without departing from the spirit and scope of the disclosed implementations.

FIG. 1A shows a block diagram of an example environment in which an on-demand database service can be used according to some implementations.

FIG. 1B shows a block diagram of example implementations of elements of FIG. 1A and example interconnections between these elements according to some implementations.

FIG. 2A shows a system diagram of example architectural components of an on-demand database service environment according to some implementations.

FIG. 2B shows a system diagram further illustrating example architectural components of an on-demand database service environment according to some implementations.

FIG. 3 shows a block diagram of a system for meeting initiation based on physical proximity in an embodiment.

FIG. 4 is an operational flow diagram illustrating a process that may be performed by the processing device of the application server of FIG. 3.

FIG. 5 is a signaling diagram illustrating selected messaging between the application server, the remote device, and a network component in an embodiment.

### DETAILED DESCRIPTION

Examples of systems, apparatus, computer-readable storage media, and methods according to the disclosed implementations are described in this section. These examples are being provided solely to add context and aid in the understanding of the disclosed implementations. It will thus be apparent to one skilled in the art that the disclosed implementations may be practiced without some or all of the specific details provided. In other instances, certain process or method operations, also referred to herein as “blocks,” have not been described in detail in order to avoid unnecessarily obscuring the disclosed implementations. Other implementations and applications also are possible, and as such, the following examples should not be taken as definitive or limiting either in scope or setting.

In the following detailed description, references are made to the accompanying drawings, which form a part of the description and in which are shown, by way of illustration, specific implementations. Although these disclosed implementations are described in sufficient detail to enable one skilled in the art to practice the implementations, it is to be understood that these examples are not limiting, such that other implementations may be used and changes may be made to the disclosed implementations without departing from their spirit and scope. For example, the blocks of the methods shown and described herein are not necessarily performed in the order indicated in some other implementations. Additionally, in some other implementations, the disclosed methods may include more or fewer blocks than are described. As another example, some blocks described herein as separate blocks may be combined in some other implementations. Conversely, what may be described herein as a single block may be implemented in multiple blocks in some other implementations. Additionally, the conjunction “or” is intended herein in the inclusive sense where appropriate unless otherwise indicated; that is, the phrase “A, B or C” is intended to include the possibilities of “A,” “B,” “C,” “A and B,” “B and C,” “A and C” and “A, B and C.”

Some implementations described and referenced herein are directed to systems, apparatus, computer-implemented methods and computer-readable storage media for meeting initiation based on physical proximity.

In some implementations, a processing system of a database system may determine when a device carried or worn by one of the persons of a scheduled meeting is positioned within a predetermined geographic distance from a reference. The reference may be identified in a scheduling request used to schedule the meeting, and may include meeting room equipment or a device carried or worn by a different one of the persons.

In an example where the reference is a personal portable device, e.g. a smartphone, the processing system may utilize a first smartphone carried or worn by a first meeting participant to sense a second smartphone (the reference) that is carried or worn by a second meeting participant when the participants are in physical proximity. In an example, the sensing includes receiving a signal generated by a beacon of the second smartphone.

The processing system may initialize capturing component(s) responsive to detecting the device carried or worn by the one of the persons being positioned within the predetermined geographic distance from the reference. If the physical meeting is in an equipped meeting room, the capturing component(s) may include teleconferencing equipment of the meeting room. If the physical meeting is in, say, a coffee house, the capturing component(s) may include a component of an electronic device carried or worn by one of the meeting participants, e.g. a tablet, a laptop, a smartphone, etc.

The processing system may also send, to the meeting participants, electronic messages including information that is based on an output of the capturing component(s). In an example, the processing system may cause an email or SMS message including a meeting summary to be automatically sent responsive to the meeting room becoming empty or the persons no longer being in physical proximity.

In some implementations, the users described herein are users (or “members”) of an interactive online “enterprise social network,” also referred to herein as an “enterprise social networking system,” an “enterprise collaborative network,” or more simply as an “enterprise network.” Such online enterprise networks are increasingly becoming a common way to facilitate communication among people, any of whom can be recognized as enterprise users. One example of an online enterprise social network is Chatter®, provided by salesforce.com, inc. of San Francisco, Calif. salesforce.com, inc. is a provider of enterprise social networking services, customer relationship management (CRM) services and other database management services, any of which can be accessed and used in conjunction with the techniques disclosed herein in some implementations. These various services can be provided in a cloud computing environment as described herein, for example, in the context of a multi-tenant database system. Some of the described techniques or processes can be implemented without having to install software locally, that is, on computing devices of users interacting with services available through the cloud. While the disclosed implementations may be described with reference to Chatter® and more generally to enterprise social networking, those of ordinary skill in the art should understand that the disclosed techniques are neither limited to Chatter® nor to any other services and systems provided by salesforce.com, inc. and can be implemented in the context of various other database systems such as cloud-based systems that are not part of a multi-tenant database system or which do not provide enterprise social networking services.

### I. Example System Overview

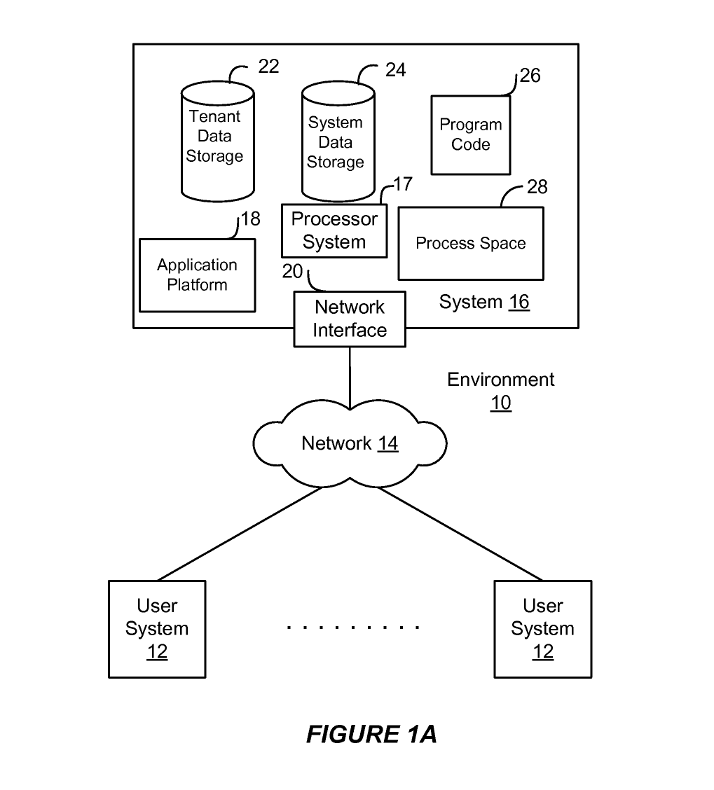

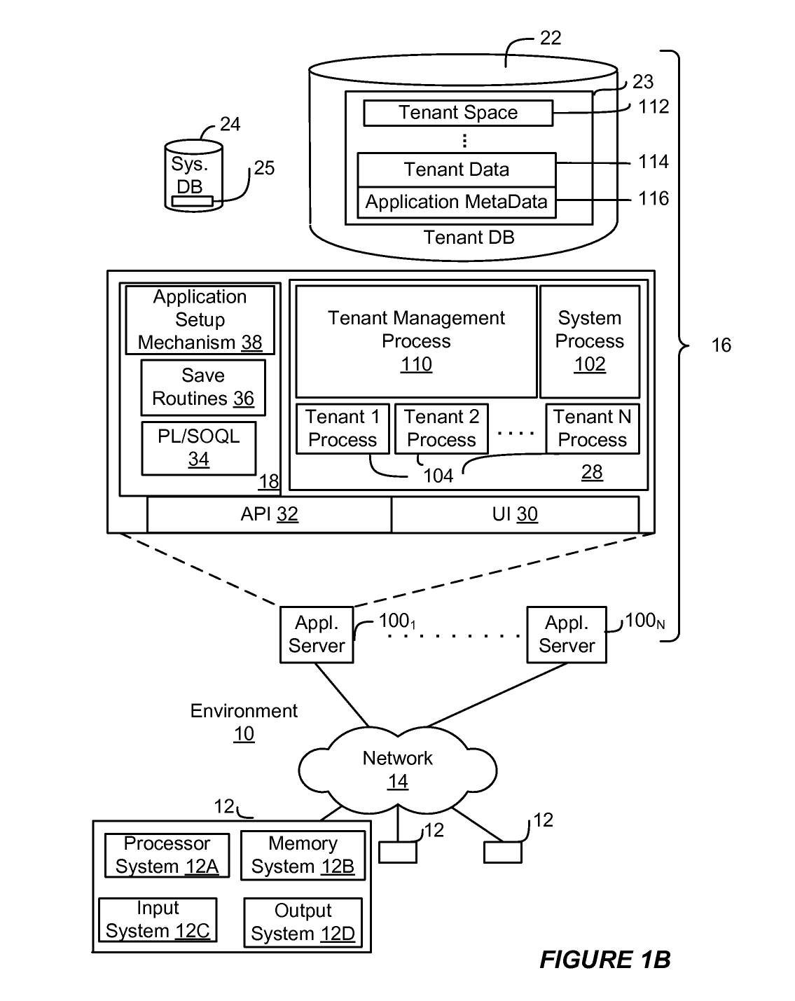

FIG. 1A shows a block diagram of an example of an environment 10 in which an on-demand database service can be used in accordance with some implementations. The environment 10 includes user systems 12, a network 14, a database system 16 (also referred to herein as a “cloud-based system”), a processor system 17, an application platform 18, a network interface 20, tenant database 22 for storing tenant data 23, system database 24 for storing system data 25, program code 26 for implementing various functions of the system 16, and process space 28 for executing database system processes and tenant-specific processes, such as running applications as part of an application hosting service. In some other implementations, environment 10 may not have all of these components or systems, or may have other components or systems instead of, or in addition to, those listed above.

In some implementations, the environment 10 is an environment in which an on-demand database service exists. An on-demand database service, such as that which can be implemented using the system 16, is a service that is made available to users outside of the enterprise(s) that own, maintain or provide access to the system 16. As described above, such users generally do not need to be concerned with building or maintaining the system 16. Instead, resources provided by the system 16 may be available for such users' use when the users need services provided by the system 16; that is, on the demand of the users. Some on-demand database services can store information from one or more tenants into tables of a common database image to form a multi-tenant database system (MTS). The term “multi-tenant database system” can refer to those systems in which various elements of hardware and software of a database system may be shared by one or more customers or tenants. For example, a given application server may simultaneously process requests for a great number of customers, and a given database table may store rows of data such as feed items for a potentially much greater number of customers. A database image can include one or more database objects. A relational database management system (RDBMS) or the equivalent can execute storage and retrieval of information against the database object(s).

Application platform 18 can be a framework that allows the applications of system 16 to execute, such as the hardware or software infrastructure of the system 16. In some implementations, the application platform 18 enables the creation, management and execution of one or more applications developed by the provider of the on-demand database service, users accessing the on-demand database service via user systems 12, or third party application developers accessing the on-demand database service via user systems 12.

In some implementations, the system 16 implements a web-based customer relationship management (CRM) system. For example, in some such implementations, the system 16 includes application servers configured to implement and execute CRM software applications as well as provide related data, code, forms, renderable web pages and documents and other information to and from user systems 12 and to store to, and retrieve from, a database system related data, objects, and Web page content. In some MTS implementations, data for multiple tenants may be stored in the same physical database object in tenant database 22. In some such implementations, tenant data is arranged in the storage medium(s) of tenant database 22 so that data of one tenant is kept logically separate from that of other tenants so that one tenant does not have access to another tenant's data, unless such data is expressly shared. The system 16 also implements applications other than, or in addition to, a CRM application. For example, the system 16 can provide tenant access to multiple hosted (standard and custom) applications, including a CRM application. User (or third party developer) applications, which may or may not include CRM, may be supported by the application platform 18. The application platform 18 manages the creation and storage of the applications into one or more database objects and the execution of the applications in one or more virtual machines in the process space of the system 16.

According to some implementations, each system 16 is configured to provide web pages, forms, applications, data and media content to user (client) systems 12 to support the access by user systems 12 as tenants of system 16. As such, system 16 provides security mechanisms to keep each tenant's data separate unless the data is shared. If more than one MTS is used, they may be located in close proximity to one another (for example, in a server farm located in a single building or campus), or they may be distributed at locations remote from one another (for example, one or more servers located in city A and one or more servers located in city B). As used herein, each MTS could include one or more logically or physically connected servers distributed locally or across one or more geographic locations. Additionally, the term “server” is meant to refer to a computing device or system, including processing hardware and process space(s), an associated storage medium such as a memory device or database, and, in some instances, a database application (for example, OODBMS or RDBMS) as is well known in the art. It should also be understood that “server system” and “server” are often used interchangeably herein. Similarly, the database objects described herein can be implemented as part of a single database, a distributed database, a collection of distributed databases, a database with redundant online or offline backups or other redundancies, etc., and can include a distributed database or storage network and associated processing intelligence.

The network 14 can be or include any network or combination of networks of systems or devices that communicate with one another. For example, the network 14 can be or include any one or any combination of a LAN (local area network), WAN (wide area network), telephone network, wireless network, cellular network, point-to-point network, star network, token ring network, hub network, or other appropriate configuration. The network 14 can include a TCP/IP (Transfer Control Protocol and Internet Protocol) network, such as the global internetwork of networks often referred to as the “Internet” (with a capital “I”). The Internet will be used in many of the examples herein. However, it should be understood that the networks that the disclosed implementations can use are not so limited, although TCP/IP is a frequently implemented protocol.

The user systems 12 can communicate with system 16 using TCP/IP and, at a higher network level, other common Internet protocols to communicate, such as HTTP, FTP, AFS, WAP, etc. In an example where HTTP is used, each user system 12 can include an HTTP client commonly referred to as a “web browser” or simply a “browser” for sending and receiving HTTP signals to and from an HTTP server of the system 16. Such an HTTP server can be implemented as the sole network interface 20 between the system 16 and the network 14, but other techniques can be used in addition to or instead of these techniques. In some implementations, the network interface 20 between the system 16 and the network 14 includes load sharing functionality, such as round-robin HTTP request distributors to balance loads and distribute incoming HTTP requests evenly over a number of servers. In MTS implementations, each of the servers can have access to the MTS data; however, other alternative configurations may be used instead.

The user systems 12 can be implemented as any computing device(s) or other data processing apparatus or systems usable by users to access the database system 16. For example, any of user systems 12 can be a desktop computer, a work station, a laptop computer, a tablet computer, a handheld computing device, a mobile cellular phone (for example, a “smartphone”), or any other Wi-Fi-enabled device, wireless access protocol (WAP)-enabled device, or other computing device capable of interfacing directly or indirectly to the Internet or other network. The terms “user system” and “computing device” are used interchangeably herein with one another and with the term “computer.” As described above, each user system 12 typically executes an HTTP client, for example, a web browsing (or simply “browsing”) program, such as a web browser based on the WebKit platform, Microsoft's Internet Explorer browser, Netscape's Navigator browser, Opera's browser, Mozilla's Firefox browser, or a WAP-enabled browser in the case of a cellular phone, PDA or other wireless device, or the like, allowing a user (for example, a subscriber of on-demand services provided by the system 16) of the user system 12 to access, process and view information, pages and applications available to it from the system 16 over the network 14.

Each user system 12 also typically includes one or more user input devices, such as a keyboard, a mouse, a trackball, a touch pad, a touch screen, a pen or stylus or the like, for interacting with a graphical user interface (GUI) provided by the browser on a display (for example, a monitor screen, liquid crystal display (LCD), light-emitting diode (LED) display, among other possibilities) of the user system 12 in conjunction with pages, forms, applications and other information provided by the system 16 or other systems or servers. For example, the user interface device can be used to access data and applications hosted by system 16, and to perform searches on stored data, and otherwise allow a user to interact with various GUI pages that may be presented to a user. As discussed above, implementations are suitable for use with the Internet, although other networks can be used instead of or in addition to the Internet, such as an intranet, an extranet, a virtual private network (VPN), a non-TCP/IP based network, any LAN or WAN or the like.

The users of user systems 12 may differ in their respective capacities, and the capacity of a particular user system 12 can be entirely determined by permissions (permission levels) for the current user of such user system. For example, where a salesperson is using a particular user system 12 to interact with the system 16, that user system can have the capacities allotted to the salesperson. However, while an administrator is using that user system 12 to interact with the system 16, that user system can have the capacities allotted to that administrator. Where a hierarchical role model is used, users at one permission level can have access to applications, data, and database information accessible by a lower permission level user, but may not have access to certain applications, database information, and data accessible by a user at a higher permission level. Thus, different users generally will have different capabilities with regard to accessing and modifying application and database information, depending on the users' respective security or permission levels (also referred to as “authorizations”).

According to some implementations, each user system 12 and some or all of its components are operator-configurable using applications, such as a browser, including computer code executed using a central processing unit (CPU) such as an Intel Pentium® processor or the like. Similarly, the system 16 (and additional instances of an MTS, where more than one is present) and all of its components can be operator-configurable using application(s) including computer code to run using the processor system 17, which may be implemented to include a CPU, which may include an Intel Pentium® processor or the like, or multiple CPUs.

The system 16 includes tangible computer-readable media having non-transitory instructions stored thereon/in that are executable by or used to program a server or other computing system (or collection of such servers or computing systems) to perform some of the implementation of processes described herein. For example, computer program code 26 can implement instructions for operating and configuring the system 16 to intercommunicate and to process web pages, applications and other data and media content as described herein. In some implementations, the computer code 26 can be downloadable and stored on a hard disk, but the entire program code, or portions thereof, also can be stored in any other volatile or non-volatile memory medium or device as is well known, such as a ROM or RAM, or provided on any media capable of storing program code, such as any type of rotating media including floppy disks, optical discs, digital versatile disks (DVD), compact disks (CD), microdrives, and magneto-optical disks, and magnetic or optical cards, nanosystems (including molecular memory ICs), or any other type of computer-readable medium or device suitable for storing instructions or data. Additionally, the entire program code, or portions thereof, may be transmitted and downloaded from a software source over a transmission medium, for example, over the Internet, or from another server, as is well known, or transmitted over any other existing network connection as is well known (for example, extranet, VPN, LAN, etc.) using any communication medium and protocols (for example, TCP/IP, HTTP, HTTPS, Ethernet, etc.) as are well known. It will also be appreciated that computer code for the disclosed implementations can be realized in any programming language that can be executed on a server or other computing system such as, for example, C, C++, HTML, any other markup language, Java™, JavaScript, ActiveX, any other scripting language, such as VBScript, and many other programming languages as are well known may be used. (Java™ is a trademark of Sun Microsystems, Inc.).

FIG. 1B shows a block diagram of example implementations of elements of FIG. 1A and example interconnections between these elements according to some implementations. That is, FIG. 1B also illustrates environment 10, but FIG. 1B, various elements of the system 16 and various interconnections between such elements are shown with more specificity according to some more specific implementations. Additionally, in FIG. 1B, the user system 12 includes a processor system 12A, a memory system 12B, an input system 12C, and an output system 12D. The processor system 12A can include any suitable combination of one or more processors. The memory system 12B can include any suitable combination of one or more memory devices. The input system 12C can include any suitable combination of input devices, such as one or more touchscreen interfaces, keyboards, mice, trackballs, scanners, cameras, or interfaces to networks. The output system 12D can include any suitable combination of output devices, such as one or more display devices, printers, or interfaces to networks.

In FIG. 1B, the network interface 20 is implemented as a set of HTTP application servers 100₁-100_{N}. Each application server 100, also referred to herein as an “app server”, is configured to communicate with tenant database 22 and the tenant data 23 therein, as well as system database 24 and the system data 25 therein, to serve requests received from the user systems 12. The tenant data 23 can be divided into individual tenant storage spaces 112, which can be physically or logically arranged or divided. Within each tenant storage space 112, user storage 114 and application metadata 116 can similarly be allocated for each user. For example, a copy of a user's most recently used (MRU) items can be stored to user storage 114. Similarly, a copy of MRU items for an entire organization that is a tenant can be stored to tenant storage space 112.

The process space 28 includes system process space 102, individual tenant process spaces 104 and a tenant management process space 110. The application platform 18 includes an application setup mechanism 38 that supports application developers' creation and management of applications. Such applications and others can be saved as metadata into tenant database 22 by save routines 36 for execution by subscribers as one or more tenant process spaces 104 managed by tenant management process 110, for example. Invocations to such applications can be coded using PL/SOQL 34, which provides a programming language style interface extension to API 32. A detailed description of some PL/SOQL language implementations is discussed in commonly assigned U.S. Pat. No. 7,730,478, titled METHOD AND SYSTEM FOR ALLOWING ACCESS TO DEVELOPED APPLICATIONS VIA A MULTI-TENANT ON-DEMAND DATABASE SERVICE, by Craig Weissman, issued on Jun. 1, 2010, and hereby incorporated by reference in its entirety and for all purposes. Invocations to applications can be detected by one or more system processes, which manage retrieving application metadata 116 for the subscriber making the invocation and executing the metadata as an application in a virtual machine.

The system 16 of FIG. 1B also includes a user interface (UI) 30 and an application programming interface (API) 32 to system 16 resident processes to users or developers at user systems 12. In some other implementations, the environment 10 may not have the same elements as those listed above or may have other elements instead of, or in addition to, those listed above.

Each application server 100 can be communicably coupled with tenant database 22 and system database 24, for example, having access to tenant data 23 and system data 25, respectively, via a different network connection. For example, one application server 100₁ can be coupled via the network 14 (for example, the Internet), another application server 100_{N-1} can be coupled via a direct network link, and another application server 100_{N} can be coupled by yet a different network connection. Transfer Control Protocol and Internet Protocol (TCP/IP) are examples of typical protocols that can be used for communicating between application servers 100 and the system 16. However, it will be apparent to one skilled in the art that other transport protocols can be used to optimize the system 16 depending on the network interconnections used.

In some implementations, each application server 100 is configured to handle requests for any user associated with any organization that is a tenant of the system 16. Because it can be desirable to be able to add and remove application servers 100 from the server pool at any time and for various reasons, in some implementations there is no server affinity for a user or organization to a specific application server 100. In some such implementations, an interface system implementing a load balancing function (for example, an F5 Big-IP load balancer) is communicably coupled between the application servers 100 and the user systems 12 to distribute requests to the application servers 100. In one implementation, the load balancer uses a least-connections algorithm to route user requests to the application servers 100. Other examples of load balancing algorithms, such as round robin and observed-response-time, also can be used. For example, in some instances, three consecutive requests from the same user could hit three different application servers 100, and three requests from different users could hit the same application server 100. In this manner, by way of example, system 16 can be a multi-tenant system in which system 16 handles storage of, and access to, different objects, data and applications across disparate users and organizations.

In one example storage use case, one tenant can be a company that employs a sales force where each salesperson uses system 16 to manage aspects of their sales. A user can maintain contact data, leads data, customer follow-up data, performance data, goals and progress data, etc., all applicable to that user's personal sales process (for example, in tenant database 22). In an example of a MTS arrangement, because all of the data and the applications to access, view, modify, report, transmit, calculate, etc., can be maintained and accessed by a user system 12 having little more than network access, the user can manage his or her sales efforts and cycles from any of many different user systems. For example, when a salesperson is visiting a customer and the customer has Internet access in their lobby, the salesperson can obtain critical updates regarding that customer while waiting for the customer to arrive in the lobby.

While each user's data can be stored separately from other users' data regardless of the employers of each user, some data can be organization-wide data shared or accessible by several users or all of the users for a given organization that is a tenant. Thus, there can be some data structures managed by system 16 that are allocated at the tenant level while other data structures can be managed at the user level. Because an MTS can support multiple tenants including possible competitors, the MTS can have security protocols that keep data, applications, and application use separate. Also, because many tenants may opt for access to an MTS rather than maintain their own system, redundancy, up-time, and backup are additional functions that can be implemented in the MTS. In addition to user-specific data and tenant-specific data, the system 16 also can maintain system level data usable by multiple tenants or other data. Such system level data can include industry reports, news, postings, and the like that are sharable among tenants.

In some implementations, the user systems 12 (which also can be client systems) communicate with the application servers 100 to request and update system-level and tenant-level data from the system 16. Such requests and updates can involve sending one or more queries to tenant database 22 or system database 24. The system 16 (for example, an application server 100 in the system 16) can automatically generate one or more SQL statements (for example, one or more SQL queries) designed to access the desired information. System database 24 can generate query plans to access the requested data from the database. The term “query plan” generally refers to one or more operations used to access information in a database system.

Each database can generally be viewed as a collection of objects, such as a set of logical tables, containing data fitted into predefined or customizable categories. A “table” is one representation of a data object, and may be used herein to simplify the conceptual description of objects and custom objects according to some implementations. It should be understood that “table” and “object” may be used interchangeably herein. Each table generally contains one or more data categories logically arranged as columns or fields in a viewable schema. Each row or element of a table can contain an instance of data for each category defined by the fields. For example, a CRM database can include a table that describes a customer with fields for basic contact information such as name, address, phone number, fax number, etc. Another table can describe a purchase order, including fields for information such as customer, product, sale price, date, etc. In some MTS implementations, standard entity tables can be provided for use by all tenants. For CRM database applications, such standard entities can include tables for case, account, contact, lead, and opportunity data objects, each containing pre-defined fields. As used herein, the term “entity” also may be used interchangeably with “object” and “table.”

In some MTS implementations, tenants are allowed to create and store custom objects, or may be allowed to customize standard entities or objects, for example by creating custom fields for standard objects, including custom index fields. Commonly assigned U.S. Pat. No. 7,779,039, titled CUSTOM ENTITIES AND FIELDS IN A MULTI-TENANT DATABASE SYSTEM, by Weissman et al., issued on Aug. 17, 2010, and hereby incorporated by reference in its entirety and for all purposes, teaches systems and methods for creating custom objects as well as customizing standard objects in a multi-tenant database system. In some implementations, for example, all custom entity data rows are stored in a single multi-tenant physical table, which may contain multiple logical tables per organization. It is transparent to customers that their multiple “tables” are in fact stored in one large table or that their data may be stored in the same table as the data of other customers.

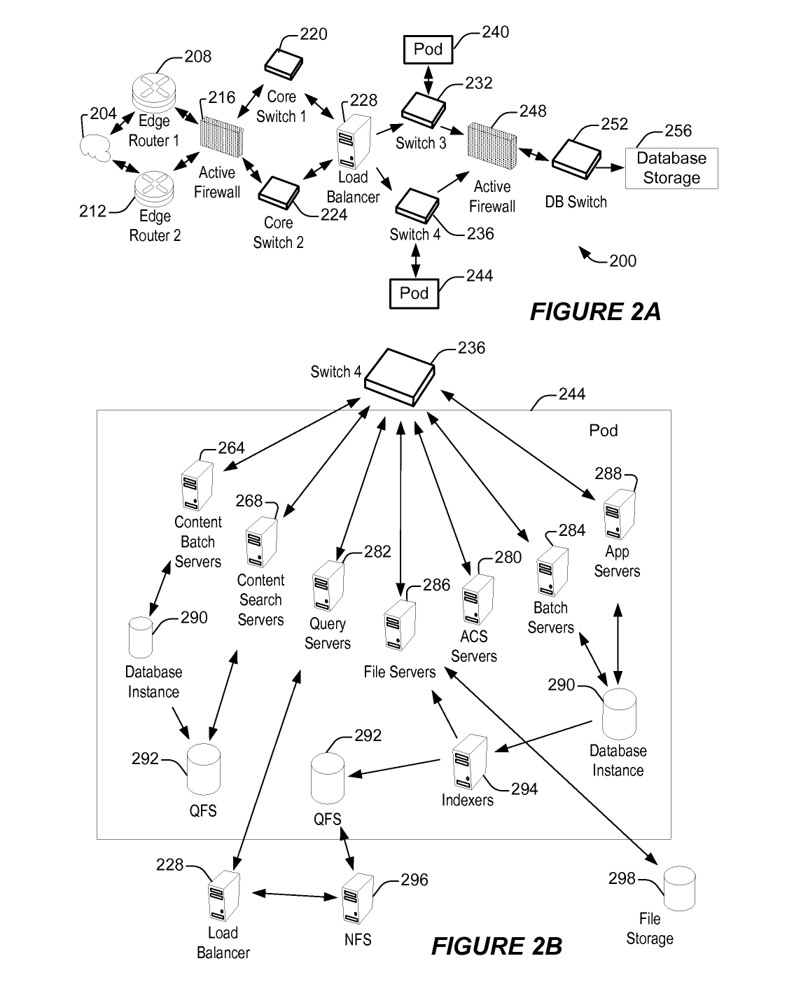

FIG. 2A shows a system diagram illustrating example architectural components of an on-demand database service environment 200 according to some implementations. A client machine communicably connected with the cloud 204, generally referring to one or more networks in combination, as described herein, can communicate with the on-demand database service environment 200 via one or more edge routers 208 and 212. A client machine can be any of the examples of user systems 12 described above. The edge routers can communicate with one or more core switches 220 and 224 through a firewall 216. The core switches can communicate with a load balancer 228, which can distribute server load over different pods, such as the pods 240 and 244. The pods 240 and 244, which can each include one or more servers or other computing resources, can perform data processing and other operations used to provide on-demand services. Communication with the pods can be conducted via pod switches 232 and 236. Components of the on-demand database service environment can communicate with database storage 256 through a database firewall 248 and a database switch 252.

As shown in FIGS. 2A and 2B, accessing an on-demand database service environment can involve communications transmitted among a variety of different hardware or software components. Further, the on-demand database service environment 200 is a simplified representation of an actual on-demand database service environment. For example, while only one or two devices of each type are shown in FIGS. 2A and 2B, some implementations of an on-demand database service environment can include anywhere from one to several devices of each type. Also, the on-demand database service environment need not include each device shown in FIGS. 2A and 2B, or can include additional devices not shown in FIGS. 2A and 2B.

Additionally, it should be appreciated that one or more of the devices in the on-demand database service environment 200 can be implemented on the same physical device or on different hardware. Some devices can be implemented using hardware or a combination of hardware and software. Thus, terms such as “data processing apparatus,” “machine,” “server” and “device” as used herein are not limited to a single hardware device, rather references to these terms can include any suitable combination of hardware and software configured to provide the described functionality.

The cloud 204 is intended to refer to a data network or multiple data networks, often including the Internet. Client machines communicably connected with the cloud 204 can communicate with other components of the on-demand database service environment 200 to access services provided by the on-demand database service environment. For example, client machines can access the on-demand database service environment to retrieve, store, edit, or process information. In some implementations, the edge routers 208 and 212 route packets between the cloud 204 and other components of the on-demand database service environment 200. For example, the edge routers 208 and 212 can employ the Border Gateway Protocol (BGP). The BGP is the core routing protocol of the Internet. The edge routers 208 and 212 can maintain a table of IP networks or ‘prefixes’, which designate network reachability among autonomous systems on the Internet.

In some implementations, the firewall 216 can protect the inner components of the on-demand database service environment 200 from Internet traffic. The firewall 216 can block, permit, or deny access to the inner components of the on-demand database service environment 200 based upon a set of rules and other criteria. The firewall 216 can act as one or more of a packet filter, an application gateway, a stateful filter, a proxy server, or any other type of firewall.

In some implementations, the core switches 220 and 224 are high-capacity switches that transfer packets within the on-demand database service environment 200. The core switches 220 and 224 can be configured as network bridges that quickly route data between different components within the on-demand database service environment. In some implementations, the use of two or more core switches 220 and 224 can provide redundancy or reduced latency.

In some implementations, the pods 240 and 244 perform the core data processing and service functions provided by the on-demand database service environment. Each pod can include various types of hardware or software computing resources. An example of the pod architecture is discussed in greater detail with reference to FIG. 2B. In some implementations, communication between the pods 240 and 244 is conducted via the pod switches 232 and 236. The pod switches 232 and 236 can facilitate communication between the pods 240 and 244 and client machines communicably connected with the cloud 204, for example via core switches 220 and 224. Also, the pod switches 232 and 236 may facilitate communication between the pods 240 and 244 and the database storage 256. In some implementations, the load balancer 228 can distribute workload between the pods 240 and 244. Balancing the on-demand service requests between the pods can assist in improving the use of resources, increasing throughput, reducing response times, or reducing overhead. The load balancer 228 may include multilayer switches to analyze and forward traffic.

In some implementations, access to the database storage 256 is guarded by a database firewall 248. The database firewall 248 can act as a computer application firewall operating at the database application layer of a protocol stack. The database firewall 248 can protect the database storage 256 from application attacks such as structure query language (SQL) injection, database rootkits, and unauthorized information disclosure. In some implementations, the database firewall 248 includes a host using one or more forms of reverse proxy services to proxy traffic before passing it to a gateway router. The database firewall 248 can inspect the contents of database traffic and block certain content or database requests. The database firewall 248 can work on the SQL application level atop the TCP/IP stack, managing applications' connection to the database or SQL management interfaces as well as intercepting and enforcing packets traveling to or from a database network or application interface.

In some implementations, communication with the database storage 256 is conducted via the database switch 252. The multi-tenant database storage 256 can include more than one hardware or software components for handling database queries. Accordingly, the database switch 252 can direct database queries transmitted by other components of the on-demand database service environment (for example, the pods 240 and 244) to the correct components within the database storage 256. In some implementations, the database storage 256 is an on-demand database system shared by many different organizations as described above with reference to FIGS. 1A and 1B.

FIG. 2B shows a system diagram further illustrating example architectural components of an on-demand database service environment according to some implementations. The pod 244 can be used to render services to a user of the on-demand database service environment 200. In some implementations, each pod includes a variety of servers or other systems. The pod 244 includes one or more content batch servers 264, content search servers 268, query servers 282, file force servers 286, access control system (ACS) servers 280, batch servers 284, and app servers 288. The pod 244 also can include database instances 290, quick file systems (QFS) 292, and indexers 294. In some implementations, some or all communication between the servers in the pod 244 can be transmitted via the switch 236.

In some implementations, the app servers 288 include a hardware or software framework dedicated to the execution of procedures (for example, programs, routines, scripts) for supporting the construction of applications provided by the on-demand database service environment 200 via the pod 244. In some implementations, the hardware or software framework of an app server 288 is configured to execute operations of the services described herein, including performance of the blocks of various methods or processes described herein. In some alternative implementations, two or more app servers 288 can be included and cooperate to perform such methods, or one or more other servers described herein can be configured to perform the disclosed methods.

The content batch servers 264 can handle requests internal to the pod. Some such requests can be long-running or not tied to a particular customer. For example, the content batch servers 264 can handle requests related to log mining, cleanup work, and maintenance tasks. The content search servers 268 can provide query and indexer functions. For example, the functions provided by the content search servers 268 can allow users to search through content stored in the on-demand database service environment. The file force servers 286 can manage requests for information stored in the Fileforce storage 298. The Fileforce storage 298 can store information such as documents, images, and basic large objects (BLOBs). By managing requests for information using the file force servers 286, the image footprint on the database can be reduced. The query servers 282 can be used to retrieve information from one or more file systems. For example, the query system 282 can receive requests for information from the app servers 288 and transmit information queries to the NFS 296 located outside the pod.

The pod 244 can share a database instance 290 configured as a multi-tenant environment in which different organizations share access to the same database. Additionally, services rendered by the pod 244 may call upon various hardware or software resources. In some implementations, the ACS servers 280 control access to data, hardware resources, or software resources. In some implementations, the batch servers 284 process batch jobs, which are used to run tasks at specified times. For example, the batch servers 284 can transmit instructions to other servers, such as the app servers 288, to trigger the batch jobs.

In some implementations, the QFS 292 is an open source file system available from Sun Microsystems® of Santa Clara, Calif. The QFS can serve as a rapid-access file system for storing and accessing information available within the pod 244. The QFS 292 can support some volume management capabilities, allowing many disks to be grouped together into a file system. File system metadata can be kept on a separate set of disks, which can be useful for streaming applications where long disk seeks cannot be tolerated. Thus, the QFS system can communicate with one or more content search servers 268 or indexers 294 to identify, retrieve, move, or update data stored in the network file systems 296 or other storage systems.

In some implementations, one or more query servers 282 communicate with the NFS 296 to retrieve or update information stored outside of the pod 244. The NFS 296 can allow servers located in the pod 244 to access information to access files over a network in a manner similar to how local storage is accessed. In some implementations, queries from the query servers 282 are transmitted to the NFS 296 via the load balancer 228, which can distribute resource requests over various resources available in the on-demand database service environment. The NFS 296 also can communicate with the QFS 292 to update the information stored on the NFS 296 or to provide information to the QFS 292 for use by servers located within the pod 244.

In some implementations, the pod includes one or more database instances 290. The database instance 290 can transmit information to the QFS 292. When information is transmitted to the QFS, it can be available for use by servers within the pod 244 without using an additional database call. In some implementations, database information is transmitted to the indexer 294. Indexer 294 can provide an index of information available in the database 290 or QFS 292. The index information can be provided to file force servers 286 or the QFS 292.

### II. Meeting Initiation Based on Physical Proximity

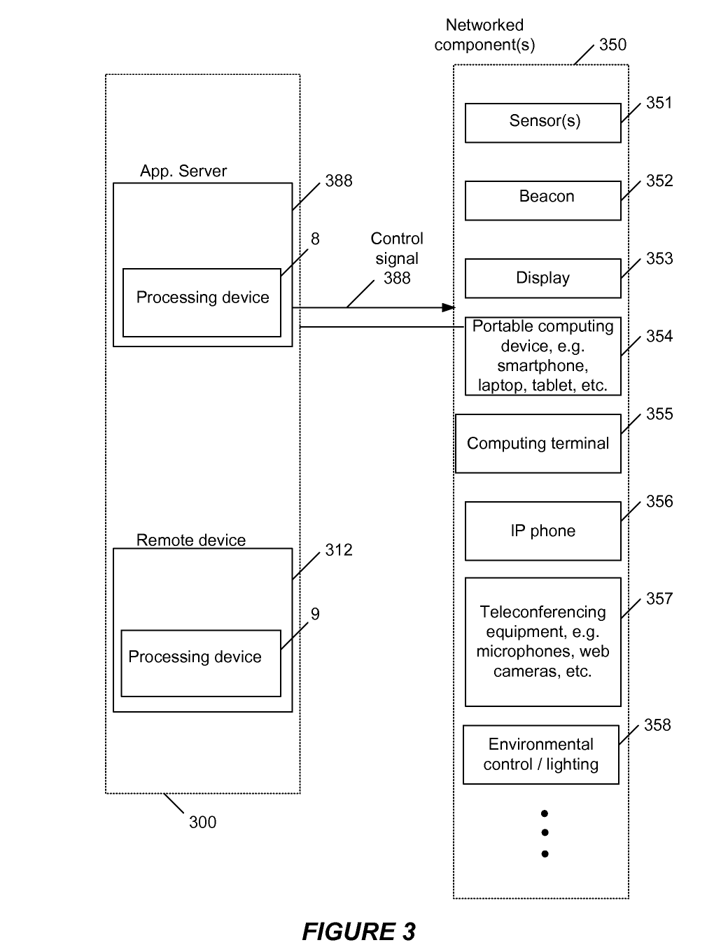

FIG. 3 shows a block diagram of a system for meeting initiation based on physical proximity in an embodiment.

The system 300 may include an application server 388 and a remote device 312. The application server 388 may include a processing device 8 configured to initiate a meeting based on physical proximity. The application server 388 may also be configured to perform the same or similar functions as the application server 288 (FIG. 2B).

Referring again to FIG. 3, the remote device 312 may include a processing device 9 that is configured, in some embodiments, to transmit an indication to the application server 388 when physical proximity to a device of another meeting participant is detected or when physical proximity to an equipped meeting room is detected. In an example, the remote device 312 is an electronic device carried or worn by one of the meeting participants, and may be configured to detect a signal from a beacon of a meeting room or a portable device carried or worn by another one of the meeting participants.

The system 300 may, in some embodiments, be coupled over a network to network component(s) 350 of an equipped meeting room (however, in other embodiments the system 300 may be utilized for a meeting in a non-equipped room using equipment carried or worn by the meeting participants). Examples of network components 350 of an equipped meeting room are a sensor 351, a beacon 352, a display 353, a portable computing device 354, a computing terminal 355, an IP phone 356, teleconferencing equipment 357, environmental controls/lighting 358, or the like, or combinations thereof. In an example, beacon 352 is an iBeacon (trademark of Apple Inc.).

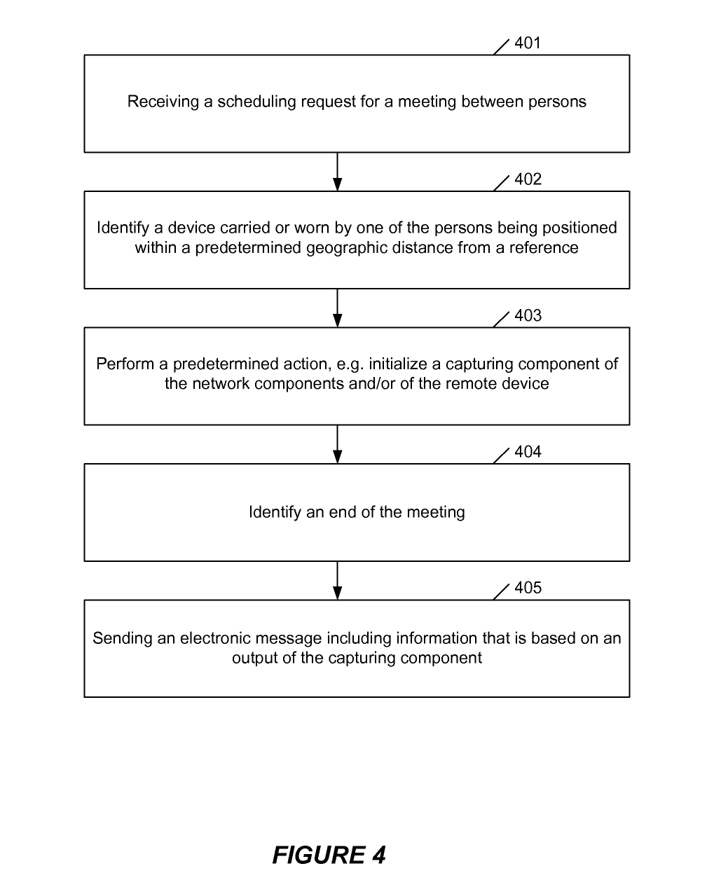

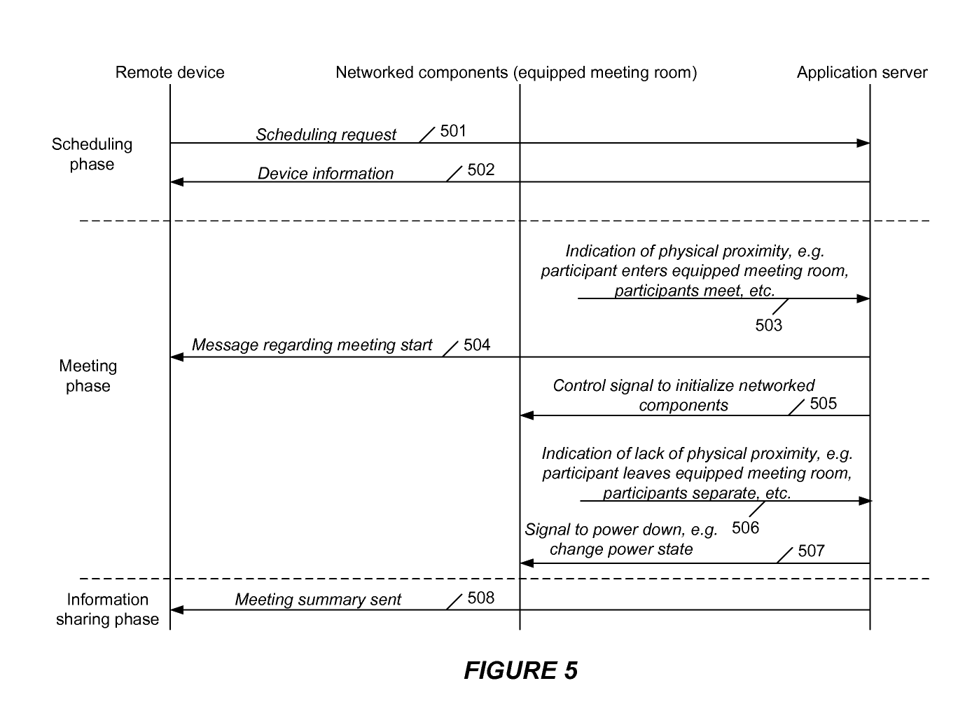

Various communications may be sent between the system 300 and the network component(s) 350 when a meeting is held in an equipped meeting room. For instance, the system 300 may send a control signal 388 to initialize a display 353, a portable computing device 354, a computing terminal 355, an IP phone 356, teleconferencing equipment 357, environmental controls/lighting 358, or the like, or combinations thereof, responsive to the remote device 312 being positioned within a predetermined distance from a reference. In an example, initializing the network component(s) 350 includes powering up, e.g. changing a power state of a capturing component of the network component 350 and/or causing an event logging service of the network component(s) to run during the meeting. Other electronic communications (not shown) that may be sent between the system 300 and the network component(s) 350 will become apparent in the descriptions of FIG. 4 and/or FIG. 5.

FIG. 4 is an operational flow diagram illustrating a process that may be performed by the processing device of the application server of FIG. 3.

In block 401, the processing device 8 may receive a scheduling request for a meeting between persons. In an example, the scheduling request may specify date/time information, meeting participant information, and digital workspace information. If a meeting room is specified, the scheduling request may include meeting room information, which may identify a particular meeting room and/or a constraint for selecting a meeting room from a set of meeting rooms.

In block 402, the processing device 8 may identify a device carried or worn by one of the persons being positioned within a predetermined geographic distance from a reference. In an example, the processing device 9 of the remote device 312 may detect (using a sensor of the remote device 312) a signal from beacon 352 of the meeting room or a beacon of a portable device of another meeting participant, and signal the processing device 8 responsive to the detection. In an example, the processing device 8 may determine when a location indicated by a GPS device of a portable device carried or worn by one of the persons is positioned within a predetermined geographic distance from the reference.

In another example, the processing device 8 may receive information collected by the sensor 351 of the meeting room. The sensor 351 may be configured to detect a beacon, an RFID tag, a Bluetooth transceiver, or the like, or combinations thereof, of the remote device 312. In some examples, the processing device 8 may compare an identifier of a portable device corresponding to one of the meeting participants to received information from the sensor 351. The identifier may be taken from the participant information, or determined by the processing device 8 responsive to data of the participant information using a profile for the corresponding participant.

Having determined that a meeting participant is in physical proximity to the scheduled meeting room and/or another meeting participant, in block 403 the processing device 8 performs a predetermined action. In an example, the processing device 8 initializes a capturing component of the meeting room and/or signals the processing device 9 to initialize a capturing component of the remote device 312. In an example, the capturing component includes a microphone, a web camera, an event logging service, or the like, or combinations thereof.

In an example, performing the predetermined action includes the processing device 8 or the processing device 9 causing at least of the following to be performed: auto logging meetings, auto connecting users in a meeting room into a Chatter group (to perform follow up work), auto starting video conferencing/phone dialing to one or more remote meeting participants, auto note sharing amongst meeting participants, tracking meeting room usage during the meeting (based on sensors located in the meeting room), auto notifications through mobile devices (e.g. auto notifications through S1) of participants joining the meeting (e.g. participants in the meeting room) and leaving the meeting (follow up tasks, etc.), or the like, or combinations thereof.

In block 404, the processing device 8 identifies an end of the meeting. In an example, the processing device 9 of the remote device 312 may send a signal that the beacon is not longer in range. In another example, the processing device 8 may receive information collected by the sensor 351 of the meeting room indicating non-occupancy. The processing device 9 may record that the equipped room is unoccupied, and may power down any number of the network component(s) 350.

In block 405, the processing device 9 may send an electronic message including information that is based on an output of the capturing component. The electronic message may be sent to a subset of the meeting participants, or all the meeting participants. In an example, the summary may include information determined by extracting data from an event log generated by the capture component during the meeting. In an example, the summary may also include information associated with the physical proximity detection, e.g. who arrived to the meeting room at what time, which persons met at what time (in the case of a non-equipped meeting room), etc.

FIG. 5 is a signaling diagram illustrating selected messaging between the application server, the remote device, and a network component in an embodiment.

In the scheduling phase, the application server receives a signal 501 including a scheduling request. In the illustrated example, the scheduling request originates from the remote device. However, in other examples, the signal 501 could originate from a different device and could indicate the remote device by the scheduling request. For example, a person could logon to a meeting service using any device and provide information about the meeting to be scheduled (and the service may already have information about remote device from a profile of the person). The application server may process the scheduling request and send a meeting notification to each meeting participant. The meeting notifications may be sent via email, SMS, or the like, or combinations thereof, to each meeting participant identified in the scheduling request.

In the present example, the application server may also send signal 502 including device information. The device information of the signal 502 may include beacon information and may enable the remote device to recognize a beacon in the meeting room, or a beacon of a portable device of another meeting participant.

Later, in the meeting phase, the application server may receive signal 503 including an indication of physical proximity, e.g. at least one participant enters an equipped meeting room or at least two participants meet. The signal 503 may originate from the network component(s) in the case of a meeting room sensor being utilized, or the signal 503 may originate from remote device in the case of the remote device detecting a beacon.

The application server transmits signal 504 regarding a meeting start. In an example, the signal 504 may be sent to all meeting participants and indicate that the meeting has begun.

If the meeting is in an equipped meeting room, the application server may send signal 505 including a control signal to initialize networked components. In an example where the meeting is without an equipped meeting room, a similar signal may instead be sent to the remote device to cause a capture component of the remote device to be initialized.

When a meeting participant leaves the meeting room or the meeting participants separate, the application server receives a signal 506 indicating the lack of physical proximity. The application server may send signal 507 to power down the networked components, e.g. change a power state of the networked components.

In an information sharing phase, the application server sends a signal 508 including a meeting summary. The meeting summary may include a portion of information captured by a component corresponding to the control signal of signal 505. The meeting summary may be sent to a device corresponding to each meeting participant. In the present example, the signal 508 is sent to the remote device; however, it should be understood that the signal 508 may be sent via email or SMS and may be accessed by any device as desired by the meeting participant.

The system and apparatus described above may use dedicated processor systems, micro controllers, programmable logic devices, microprocessors, or any combination thereof, to perform some or all of the operations described herein. Some of the operations described above may be implemented in software and other operations may be implemented in hardware. Any of the operations, processes, and/or methods described herein may be performed by an apparatus, a device, and/or a system substantially similar to those as described herein and with reference to the illustrated figures.

The processing system may execute instructions or “code” stored in memory. The memory may store data as well. The processing system may include, but may not be limited to, an analog processor, a digital processor, a microprocessor, a multi-core processor, a processor array, a network processor, or the like. The processing system may be part of an integrated control system or system manager, or may be provided as a portable electronic device configured to interface with a networked system either locally or remotely via wireless transmission.

The processor memory may be integrated together with the processing system, for example RAM or FLASH memory disposed within an integrated circuit microprocessor or the like. In other examples, the memory may comprise an independent device, such as an external disk drive, a storage array, a portable FLASH key fob, or the like. The memory and processing system may be operatively coupled together, or in communication with each other, for example by an I/O port, a network connection, or the like, and the processing system may read a file stored on the memory. Associated memory may be “read only” by design (ROM) by virtue of permission settings, or not. Other examples of memory may include, but may not be limited to, WORM, EPROM, EEPROM, FLASH, or the like, which may be implemented in solid state semiconductor devices. Other memories may comprise moving parts, such as a known rotating disk drive. All such memories may be “machine-readable” and may be readable by a processing system.

Operating instructions or commands may be implemented or embodied in tangible forms of stored computer software (also known as “computer program” or “code”). Programs, or code, may be stored in a digital memory and may be read by the processing system. “Computer-readable storage medium” (or alternatively, “machine-readable storage medium”) may include all of the foregoing types of memory, as well as new technologies of the future, as long as the memory may be capable of storing digital information in the nature of a computer program or other data, at least temporarily, and as long as the stored information may be “read” by an appropriate processing system. The term “computer-readable” may not be limited to the historical usage of “computer” to imply a complete mainframe, mini-computer, desktop or even laptop computer. Rather, “computer-readable” may comprise storage medium that may be readable by a processor, a processing system, or any computing system. Such media may be any available media that may be locally and/or remotely accessible by a computer or a processor, and may include volatile and non-volatile media, and removable and non-removable media, or any combination thereof.

A program stored in a computer-readable storage medium may comprise a computer program product. For example, a storage medium may be used as a convenient means to store or transport a computer program. For the sake of convenience, the operations may be described as various interconnected or coupled functional blocks or diagrams. However, there may be cases where these functional blocks or diagrams may be equivalently aggregated into a single logic device, program or operation with unclear boundaries.

While one or more implementations have been described by way of example and in terms of the specific embodiments, it is to be understood that one or more implementations are not limited to the disclosed embodiments. To the contrary, it is intended to cover various modifications and similar arrangements as would be apparent to those skilled in the art. Therefore, the scope of the appended claims should be accorded the broadest interpretation so as to encompass all such modifications and similar arrangements.

1. A database system, comprising:
a processing system; and
a memory device coupled to the processing system, the memory device having instructions stored thereon that, in response to execution by the processing system, cause the processing system to perform operations comprising:
receiving a scheduling request for a meeting between persons;
identifying a device carried or worn by one of the persons being positioned within a predetermined geographic distance from a reference;
initializing a capturing component responsive to detecting the device carried or worn by the one of the persons being positioned within the predetermined geographic distance from the reference; and
sending, to at least one of the persons, an electronic message including information that is based on an output of the capturing component.

2. The database system of claim 1, wherein the reference comprises at least one selected from meeting room equipment or a device carried or worn by a different one of the persons.

3. The database system of claim 1, wherein initializing the capturing component further comprises:
changing a power state of the capturing component; and
activating an event logging service associated with the capturing component.

4. The database system of claim 1, wherein the information of the electronic message is based in part on an event log.

5. The database system of claim 1, wherein the operations further comprise:
after initializing the capturing component, identifying the device positioned greater than the predetermined geographic distance or a different predetermined geographic distance from the reference; and
sending the meeting summary responsive to identifying the device positioned greater than the predetermined geographic distance or the different predetermined geographic distance from the reference.

6. The database system of claim 1, wherein the reference comprises equipment installed in a meeting room.

7. The database system of claim 1, wherein the reference comprises a mobile device.

8. The database system of claim 1, wherein the electronic message comprises at least one of an email or an SMS message.

9. The database system of claim 1, wherein the capturing component comprises at least one of a component of meeting room equipment or a component of a portable device of a meeting participant.

10. The database system of claim 1, wherein the monitoring process is further configured to detect a signal emanating from a beacon of the device carried or worn by the one of the persons

11. A method, comprising:
receiving a scheduling request for a meeting between persons;
initiating a monitoring process at a time corresponding to the scheduled meeting, wherein the monitoring process is configured to detect a device carried or worn by one of the persons being positioned within a predetermined geographic distance from a reference;
initializing a capturing component responsive to detecting the device carried or worn by the one of the persons being positioned within the predetermined geographic distance from the reference; and
sending, to at least one of the persons, an electronic message including information that is based on an output of the capturing component.

12. The method of claim 11, wherein the reference comprises at least one selected from meeting room equipment or a device carried or worn by a different one of the persons.

13. The method of claim 11, wherein initializing the capturing component further comprises:
changing a power state of the capturing component; and
activating an event logging service associated with the capturing component.

14. The method of claim 11, wherein the information of the electronic message is based in part on an event log.

15. The method of claim 11, wherein the reference comprises meeting room equipment, and the method further comprises:
after initializing the capturing component, detecting non-occupancy of a meeting room associated with the meeting; and
sending the meeting summary responsive to detecting non-occupancy of the meeting room associated with the meeting.

16. The method of claim 11, wherein the reference comprises a mobile device, and the method further comprises:
after initializing the capturing component, receiving an indication that a current distance between the device and the reference is greater than the predetermined geographic distance or a different predetermined geographic distance; and
sending the meeting summary responsive to receiving the indication that the current distance between the device and the reference is greater than the predetermined geographic distance or a different predetermined geographic distance.

17. The method of claim 11, wherein the electronic message comprises at least one of an email or an SMS message.

18. The method of claim 11, wherein the capturing component comprises at least one of a component of meeting room equipment or a component of a portable device of a meeting participant.

19. The method of claim 11, wherein the monitoring process is further configured to detect a signal emanating from a beacon of the device carried or worn by the one of the persons.
